(19) United States
(12) Patent Application Publication
(10) Pub. No.: US 2014/0337305 A1
(43) Pub. Date: Nov. 13, 2014

(54) GEOGRAPHIC COORDINATES BASED CONTENT SEARCH

(71) Applicant: TOLLSHARE, INC., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TOLLSHARE, INC., Danville, CA (US)

(21) Appl. No.: 13/893,075

(22) Filed: May 13, 2013

(51) Int. Cl. G06F 17/30

(52) U.S. Cl. CPC G06F 17/30241; G06F 17/30864
USPC 707/706; 707/722

(57) ABSTRACT

Apparatuses, methods and storage medium associated with geographic coordinates based content search are disclosed herein. In embodiments, a search service may be configured to analyze a plurality of contents having non-geographic coordinate content items. The analysis may include determination of whether the non-geographic coordinate content items are associated with a plurality of locations on Earth's surface. The locations may be identifiable by a plurality of geographic coordinates of a geographic coordinate system. For contents with non-geographic coordinate content items recognized to be associated a plurality of locations, the search service may generate and store indices that index the geographic coordinates of the locations to the contents with associated non-geographic coordinate content items. Other embodiments may be described and/or claimed.

### TECHNICAL FIELD

The present disclosure relates to the field of data processing, in particular, to apparatuses, methods and storage medium associated with geographic coordinates based content search.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of contents through the Internet. Today, users routinely use search services, such as Google®, Bing®, Yahoo®, and so forth, to locate information. Typically, a search service would maintain a collection of indices indexing the contents available on Internet. The indices are typically keywords based, that is based on the presence of keywords in the content and/or the metadata associated with content, such as non-textual audio/video content. For example, an index would be generated and stored to keep track that a web page with the keywords “latitude” may be potentially relevant to user searching for information with search criteria including the keyword “latitude,” and/or its synonyms. In response to a search query, the search service will utilize the keyword based indices or a subset thereof to generate and return an answer set with locators to potential relevant contents to the search query. Certain ranking and/or relevance analysis algorithm may be applied/used to filter and/or order the potential relevant contents included in the answer set.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for geographic coordinates based content search, in accordance with various embodiments.

FIG. 2 illustrates the geographic coordinates based indices of FIG. 1 in further detail, in accordance with various embodiments.

FIG. 3 illustrates an example process for generating the geographic coordinates based indices, in accordance with various embodiments.

FIG. 4 illustrates an example process for processing and responding to a search query on a geographic coordinate basis, in accordance with various embodiments.

FIG. 5 illustrates an example organization of the geographic coordinates based indices, in accordance with various embodiments.

FIG. 6 illustrates an example storage and access of the geographic coordinates based indices, in accordance with various embodiments.

FIG. 7 illustrates an example computing environment suitable for practicing the disclosure, in accordance with various embodiments.

FIG. 8 illustrates an example storage medium with instructions configured to enable an apparatus to practice the processes of the present disclosure, in accordance with various embodiments.

### DETAILED DESCRIPTION

Apparatuses, methods and storage medium associated with geographic coordinates based content search are disclosed herein. In embodiments, a search service may be configured to analyze a plurality of contents having non-geographic coordinate content items, e.g., contents available on the Internet having textual keywords. The analysis may include determination of whether the non-geographic coordinate content items are associated with a plurality of locations on Earth's surface. The locations may be identifiable by a plurality of geographic coordinates of a geographic coordinate system, e.g., geodetic latitudes and longitudes. For contents with non-geographic coordinate content items recognized to be associated with a plurality of locations, the search service may generate and store indices that index the geographic coordinates of the locations to the contents with associated non-geographic coordinate content items. The stored indices may be subsequently used to identify the indexed contents as potential relevant contents of an answer set to a search query.

Further, in embodiments, the search service may be configured to receive a search query, and in response to receipt of a search query, process the search query, and generate and return an answer set to the search query based at least in part on the stored indices. The search service may process the search query, including analysis of association of non-geographic coordinate search criteria of the search query with locations of Earth's surface. The search service may further traverse the stored geographic coordinates based indices based at least in part on geographic coordinates of the locations associated with the non-geographic coordinate search criteria.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

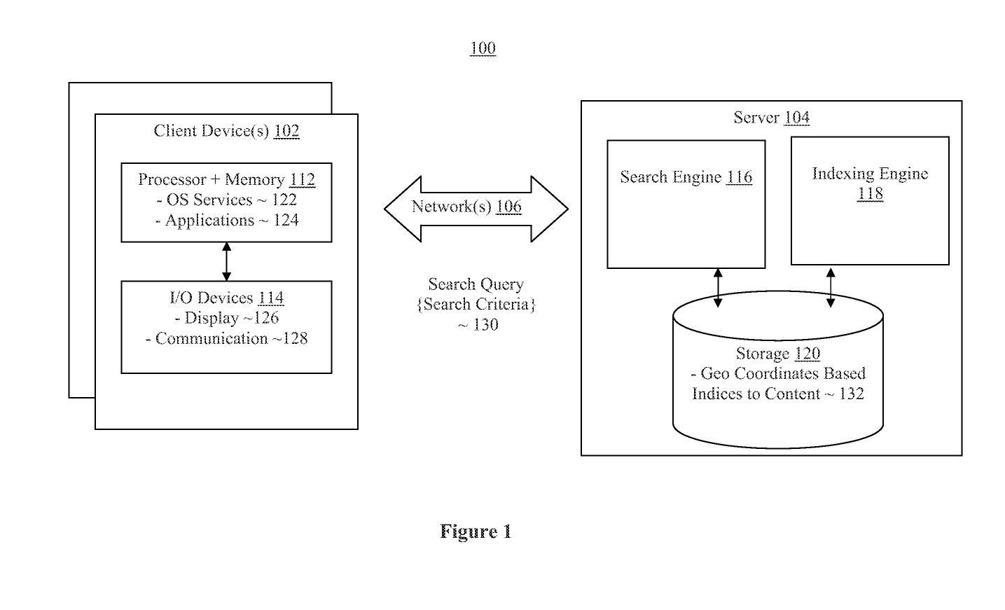

Referring now FIG. 1, wherein an arrangement for geographic coordinates based content search, in accordance with various embodiments, is illustrated. As shown, in embodiments, arrangement 100 may include server 104 configured to offer geographic coordinates based search service (GCSS) for client devices 102. Client devices 102 may be coupled to server 104 and access GCSS via network 106. Hereinafter, GCSS may simply be referred as search service.

In embodiments, server 104 may include search engine 116, indexing engine 118, and storage 120, coupled with each other as shown. In embodiments, indexing engine 118 may be configured to analyze a plurality of contents available from one or more private or public content repositories, e.g., documents and/or multi-media contents/objects available on the Internet. The analysis may include analysis of association of non-geographic coordinate content items, such as, keywords of the content or of metadata of the content, with locations on Earth's surface. The locations may be identifiable by geographic coordinates of a geographic coordinate system, e.g., geodetic latitude and longitude coordinates. Indexing engine 118 may employ a wide range of private and/or public resources to determine the association, including but not limited to information available on the Internet.

Further, indexing engine 118 may be configured to generate, for locations with associated contents, indices that index the geographic coordinates of the locations to the associated contents, e.g., to the locators of the associated contents. The locators may e.g., be uniform resource locators (URL). In embodiments, indexing engine 118 may store the generated indices 132 in storage 120. The stored indices 132 may then be subsequently accessed to enable the indexed contents to be identified as potential relevant contents in response to a content search.

For example, indexing engine 118 may analyze a web page having the keyword “San Francisco,” or a photograph having the keyword “San Francisco” in the photograph's metadata, and determine that the web page or the photograph is associated with the geodetic latitude and longitude coordinates of {37° 46′ 29.99″ -122° 25′ 5.88″}, which may be considered as the geodetic latitude and longitude coordinates of the City of San Francisco, Calif. Similarly, indexing engine may analyze a web page or metadata of a multi-media content having keywords “Candlestick Park,” “Golden Gate Bridge,” “Lombard Street,” “Coit Tower,” “Castro Street,” “Harvey Milk,” “Dianne Fienstein,” “49 Niners,” “Joe Montana,” “Ansel Adams,” “Haight Ashbury,” “Jerry Garica,” “Grateful Dead,” “Giant Baseball,” and so forth, and determine based on these keywords that the web page or multi-media content is associated with City of San Francisco. In each of these cases, indexing engine 118 may generate an index 132 to index geodetic latitude and longitude coordinates {37° 46′ 29.99″ −122° 25′ 5.88″}of San Francisco to the web page or multi-media content. The index 132 may include the geodetic latitude and longitude coordinates {37° 46′ 29.99″ −122° 25′ 5.88″} and the URL of the web page or multi-media content.

While the above example illustrated the association determination and indexing with geodetic coordinates that are valued in accordance with a mathematical defined reference ellipsoid that approximates the Earth, the present disclosure is not so limited. Other geographic coordinates with other geographic reference systems may also be used, including but are not limited to, e.g., geocentric coordinates that are valued in accordance with a X-Y-Z reference centered at Earth's center, or spherical coordinates that are valued based on the radial distances from Earth's center, along with polar angles measured from the zenith directions of the positions, and azimuth angles of the positions based on orthogonal projections on corresponding reference planes that pass through Earth's center and orthogonal to the zenith directions.

Continuing to refer to FIG. 1, search engine 116 may be configured to receive a search query 130, e.g., from one of client devices 102. Search query 130 may include a number of search criteria. The search criteria may include geographic coordinate search criteria, such as geodetic latitude and longitude, and/or non-geographic coordinate search criteria, such as, keywords or key phrases. The search criteria may be associated with qualifiers, e.g., Boolean and/or proximity qualifiers. Search engine 116 may be further configured to process the received search query, generate and return an answer set having locators to potential relevant content to the search query. Search engine 116 may be configured to generate the answer set based at least in part on the geographic coordinates based indices 132 stored in storage 120.

In embodiments, search engine 116 may be configured to analyze, as part of the processing the received search query, non-geographic coordinate search criteria of the search query to determine if there are associations between the non-geographic coordinate search criteria and locations of Earth's surface. Search engine 116 may, on determination of an association, translate or map the non-geographic coordinate search criteria to the geographic coordinates of the associated locations. Thereafter, search engine 116 may traverse the stored geographic coordinates based indices 132, using any explicitly specified geographic coordinate search criteria, and translated/mapped geographic coordinates of the non-geographic coordinate search criteria, to identify potential relevant contents. Search engine 116 may further, on identification of the potential relevant contents, generate the answer set to the search query. Search engine 116 may be configured to apply any one of a number of filtering and/or ranking operations to filter and/or organize the locators of the potentially relevant content of the answer set.

In embodiments, search engine 116 and indexing engine 118 may be implemented in any combination of hardware and/or software. In embodiments, the combination of hardware and/or software may include processor(s), memory and executable instructions implementing the functions described herein. In embodiments, in lieu of being two separate engines, search engine 116 and indexing engine 118 may share some common functions and/or resources. For example, search engine 116 and indexing engine 118 may share common communication functions and components for communicating with client devices 102 and providers of contents. As a further example, search engine 116 and indexing engine 118 may share processor and/or memory resources. In embodiments, some functions of search engine 116 may be moved to indexing engine 118, or vice versa, or be combined. Storage 120 may be implemented using any magnetic, optical, and/or solid state non-volatile storage. The magnetic, optical, and/or solid state non-volatile storage may be disposed on one platform, or coupled/networked. In embodiments, storage 120 may also include volatile and/or non-volatile caches.

Still referring to FIG. 1, client device 102 may include processor and memory arrangement 112 and input/output (I/O) devices 114 coupled with each other as shown. Processor and memory arrangement 112 may host execution of various operating system (OS) services 122 and applications 124. OS services 122 may include any one of a number of OS services known in the art, including but not limited to memory management, task management, and so forth. Similarly, applications 124 may be any one of a number of applications known in the art, including but not limited to, browsers, applications with or without location based services, and so forth. In embodiments, applications 124 may be the entities in client device 102 transmitting search query 130 to server 104. I/O devices 114 may include display 126 and communication components 128. Display 126 may be any one of a number of display devices known in the art, including but not limited to active matrix displays, touch sensitive displays and so forth. Communication components 128 may be any one of a number of communication components known in the art, including but not limited to wired or wireless communication components for personal, local and/or wide area network communications.

Thus, client device 102 represents a broad range of client devices known in the art, including but not limited to personal digital assistants (PDA), smartphones, computing tablets, ultrabook, laptop computers, desktop computers, set-top box, media players, game consoles, and so forth.

Continuing to refer to FIG. 1, networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the server end, networks 106 may include one or more local area networks with gateways and firewalls, through which servers 104 go through to communicate with client devices 102. Similarly, at the client device end, networks 106 may include base stations and/or access points, through which client devices 102 communicate with servers 104. In between the two ends may be any number of network routers, switches and other networking equipment of the like. However, for ease of understanding, these gateways, firewalls, routers, switches, base stations, access points and the like are not shown.

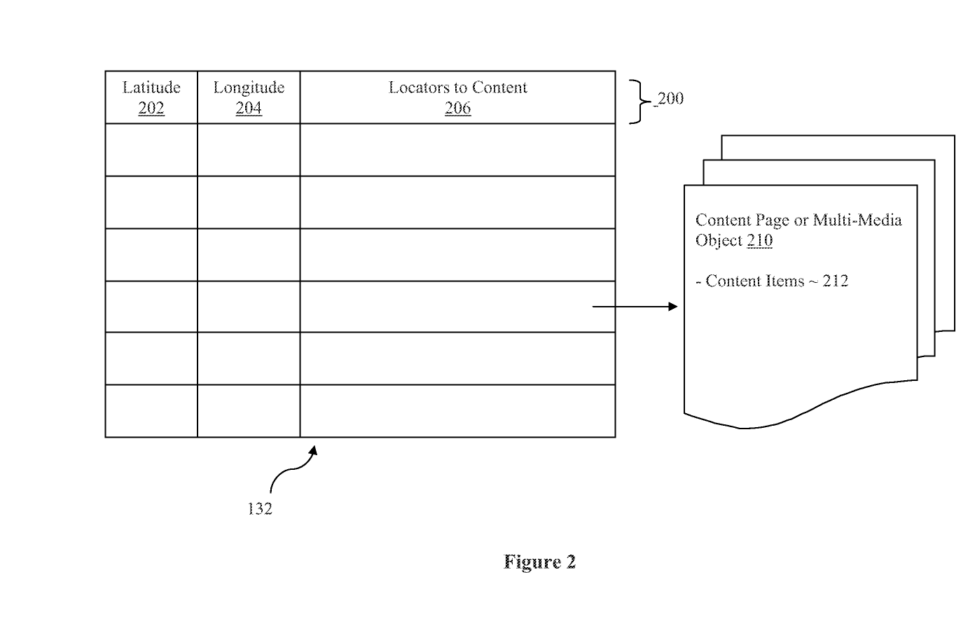

Referring now to FIG. 2, wherein the stored geographic coordinates based indices are illustrated in further detail, in accordance with various embodiments. As shown, in embodiments, each stored geographic coordinates based index 200 may include a set of geographic coordinates of a location on Earth's surface, e.g., latitude 202 and longitude 204, and a locator 206. Locator 206 may point to a location where a content page or multi-media object 210 associated with the location may be found and retrieved. The content page or multi-media object 210 was earlier determined to be associated with the location based at least in part on non-geographic coordinate content items 212 in content page 210 or in the metadata of the content page/multi-media object 210.

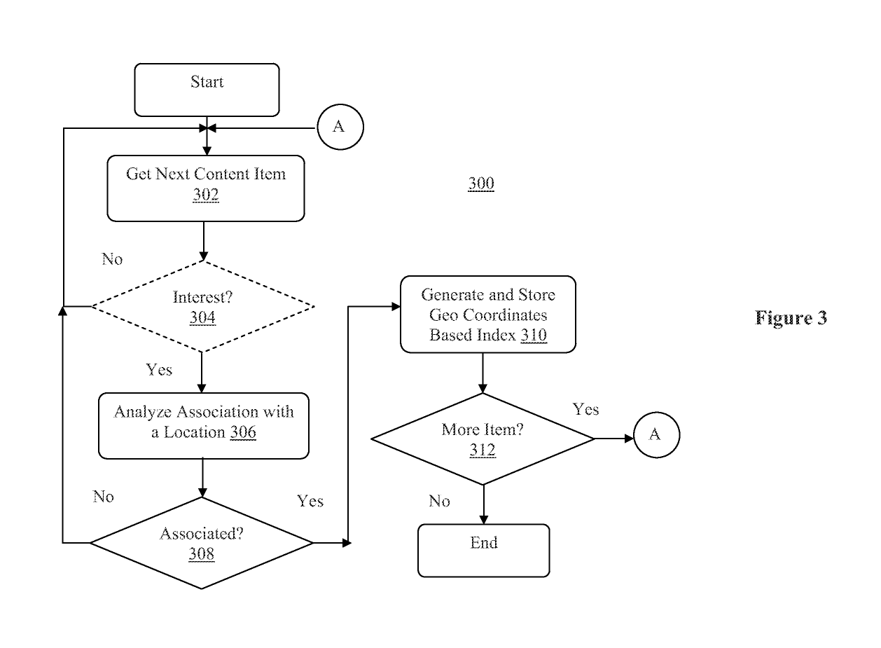

Referring now to FIG. 3, wherein an example process for generating the geographic coordinates based indices, in accordance with various embodiments, is illustrated. As shown, process 300 may start at block 302. At block 302, a next non-geographic coordinate content item may be retrieved from an information page or metadata of an information page/multi-media object retrieved from a document repository and being analyzed, e.g., by indexing engine 118. From block 302, process 300 may optionally proceed to block 304 or to block 306 directly, skipping block 304.

At block 304, a determination may be made on whether the non-geographic coordinate content item is of interest, e.g., by indexing engine 118. The determination may be made in accordance with any number of interest policies or rules. On determination that the non-geographic coordinate content item is of interest, process 300 may proceed to block 306, else process 300 may return to block 302.

At block 306, whether proceeded directly from block 302 or via block 304, the non-geographic coordinate content item may be analyzed for association with locations on Earth's surface, e.g., by indexing engine 118. As described earlier, the determination may be made employing any number of resources available privately or publicly, including resources available on the Internet. From block 306, process 300 may proceed to block 308.

At block 308, a determination may be made on whether the non-geographic coordinate content item is associated with one or more locations, e.g., by indexing engine 118. The determination may be made in accordance with results of the analysis of bock 306. On determination that the non-geographic coordinate content item is associated with one or more locations, process 300 may proceed to block 310, else process 300 may return to block 302.

At block 310, one or more geographic coordinates based indices may be generated to index the geographic coordinates of the associated locations to the content having the associated non-geographic coordinate content item, e.g., by indexing engine 118. As described earlier, the generated indices may be stored into storage 120 for subsequent use to identify potentially relevant contents for an answer set to a search query. From block 310, process 300 may proceed to block 312.

At block 312, a determination may be made on whether the all non-geographic coordinate content items of the information page or multi-media object have been processed/analyzed, e.g., by indexing engine 118. On determination that not all non-geographic coordinate content items of the information page or multi-media object have been processed/analyzed, process 300 may return to block 302, else process 300 may end.

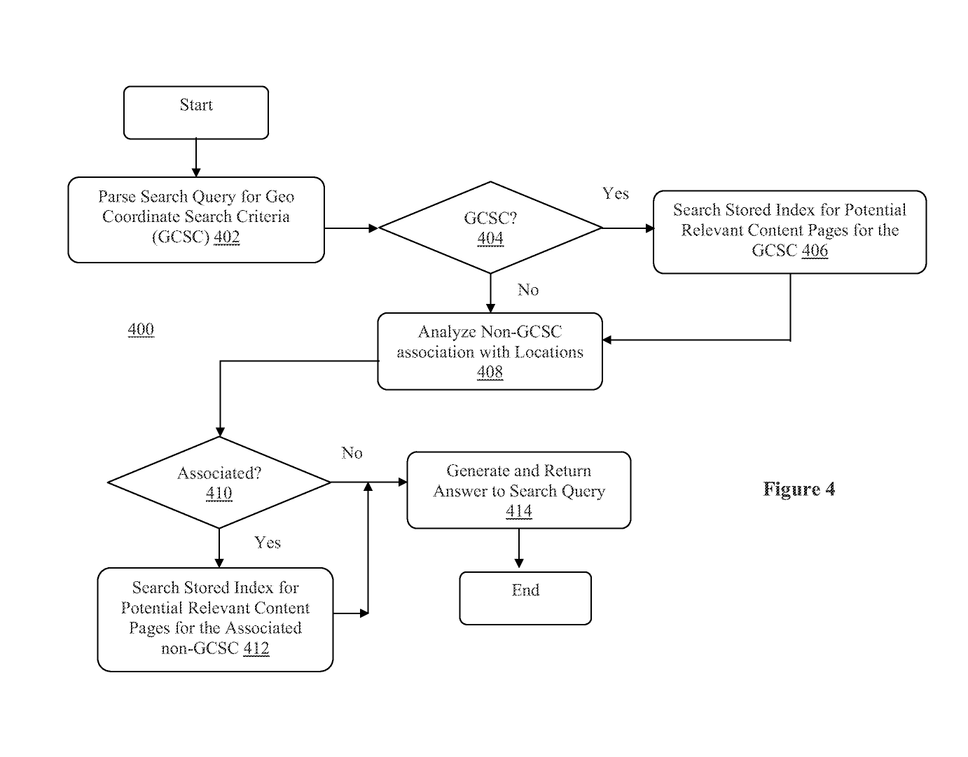

Referring now FIG. 4, wherein an example process for processing and responding to a search query on a geographic coordinate basis, in accordance with various embodiments, is illustrated. As shown, process 400 may begin at block 402. At block 402, the search query may be parsed, e.g., by search engine 116, to analyze whether the search criteria include geographic coordinate search criteria (GCSC). From block 402, process 400 may proceed to block 404.

At block 404, a determination may be made, e.g., by search engine 116, whether a result of the analysis of block 402 identified any geographic coordinate search criteria. From block 404, process 400 may proceed to block 406 if one or more geographic coordinate search criteria were identified, else process 400 may proceed to block 408.

At block 406, the stored geographic coordinates based indices may be traversed, e.g., by search engine 116, using the geographic coordinate search criteria, to identify potentially relevant contents for the search query. From block 406, process 400 may proceed to block 408.

At block 408, the non-geographic coordinate search criteria of the search query, if any, may be analyzed, e.g., by search engine 116, for association with locations. From block 408, process 400 may proceed to block 410.

At block 410, a determination may be made, e.g., by search engine 116, whether a result of the analysis of block 408 identified any association with locations. Similar to indexing engine 118, search engine 116 may use any private and/or public resources available, including resources available on the Internet, to determine association. From block 410, process 400 may proceed to block 412 if one or more associations were identified, else process 400 may proceed to block 414.

At block 412, the stored geographic coordinates based indices may be traversed, e.g., by search engine 116, using the geographic coordinates of the associated locations, to identify potentially relevant contents for the search query. The non-geographic coordinate search criteria may be translated/mapped to the geographic coordinates of the associated locations by, e.g., search engine 116. From block 412, process 400 may proceed to block 414.

At block 414, the traversal results from block 406 and/or block 412 may be used, e.g., by search engine 116, to generate and return an answer set with locators to potential relevant contents to the search query. As described earlier, any number of filtering and/or ranking may be applied to filter and/or organize the locators of the potentially relevant contents. From block 414, on return of the answer set to the search query, process 400 may end.

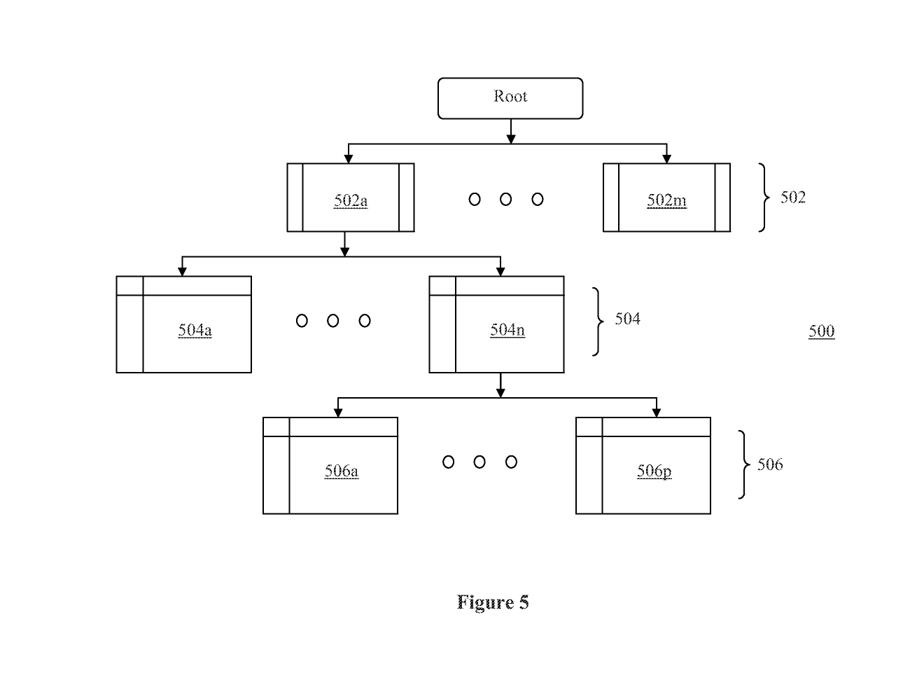

Referring now briefly back to FIG. 2, in embodiments, the geographic coordinates 132 may be stored in storage 120 in any one of a number of data organizations or structures, to facilitate efficient traversal for identification of potential relevant contents. FIG. 5 illustrates an example organization of the geographic coordinates based indices, in accordance with various embodiments. Example organization 500 may be a hierarchical organization/structure having a number of organization levels, including one or more intermediate or node levels 502-504 and the lowest or leaf level 506. In embodiments, geographical coordinate based indices having geographic coordinates of various locations indexing the locations to associated contents may be stored in the lowest or leaf level 506, such as 506a . . . 506p. Further, geographical coordinate based indices having geographic coordinate ranges defining areas and/or regions of various sizes indexing the areas/regions to each other and to the contents may be stored in the one or more intermediate levels 502, 504, and so forth, such as 502a . . . 502m and 504a . . . 504n.

For example, in one embodiment, the lowest level 506 may store the geographic coordinates based indices indexing cities, such as San Francisco, Los Angeles, to associated contents. A next immediate intermediate level, e.g., level 504, may store geographic coordinate ranges defining States, such as California, Oregon, indexing the states to the indices of the cities within the States. Further, another intermediate level (not shown) above intermediate level 504 may store geographic coordinate ranges representing Countries, such as United States, Canada, indexing the Countries to the indices of the States or Provinces within the Countries. Still further, yet another intermediate level, such as intermediate level 502 may store geographic coordinate ranges representing Continents, such as North America, Europe and so forth, indexing the Continents to the indices of the Countries.

The above example is not intended to be limiting on the present disclosure. The present disclosure may be practiced with any data organization or structure, depending on the application. In the case of hierarchical organization, the hierarchical organization may have any number of levels, with the nodes of the intermediate levels storing geographic coordinate ranges defining any geographic, political, cultural, social, and/or economic organizations.

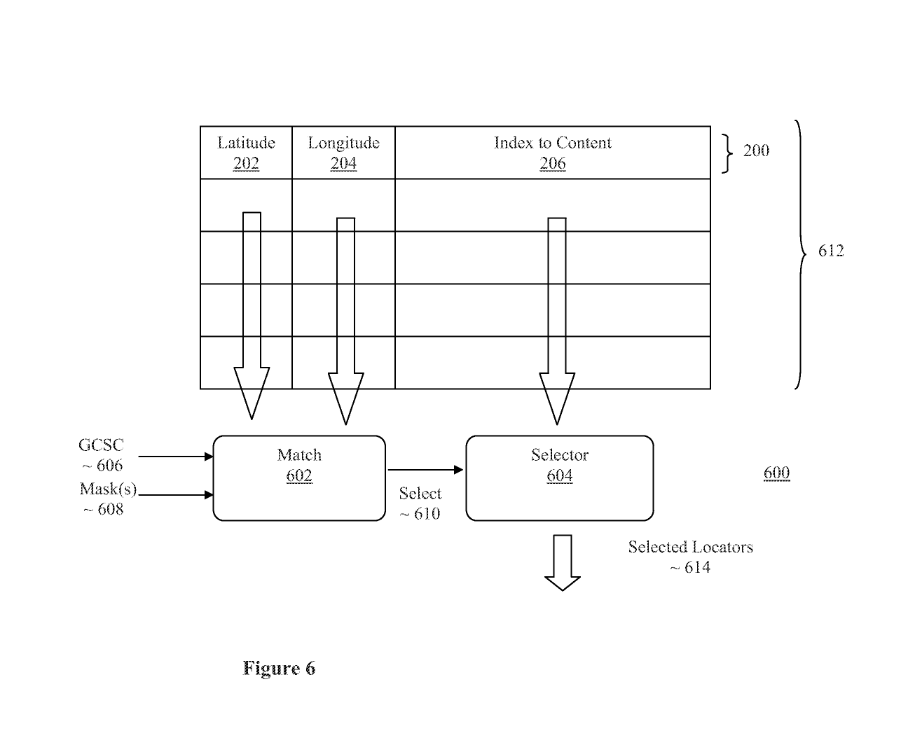

FIG. 6 illustrates an example storage and access of the geographic coordinates based indices, in accordance with various embodiments. In applications/embodiments, or in a particular instance in time in the use of an application, geographical coordinates based indices of interest may be a limited finite subset of the entire volume of indices 132 indexing the many areas, regions, positions of Earth to the multiplicity of contents available, maintained by server 104. For example, a portable or handheld client device 102 may be provided with the subset of geographical coordinates based indices indexing the areas, regions and positions of California to associated contents, if the application or an instant use of the application is known to be confined in California. The example subset is not meant to be limiting, other subset derivations of the larger set of indices are also possible and anticipated.

For the example applications/embodiments, the subset of geographic coordinates based indices 132 may be stored in a content addressable memory (CAM) 600 on client device 102. CAM 600, in addition to storage locations 612 for storing each 200 of the subset of indices, may be configured with match circuitry 602 and selector 604, coupled with each other as shown. A copy of search engine 116 provided to client device 102, which may have reduced functions, on access of CAM 600 may also provide geographic coordinates based search criteria 606, optionally accompanied with one or more masks 608.

On access, storage locations may output geographic coordinates 202-204 and locators 206 to associated contents to match circuitry 602 and selector 604 respectively. Match circuitry 602 may output one or more select signals 610 to selector 604, based on geographic coordinates 202-204, geographic coordinates based search criteria (GCSC) 606, and mask(s) 608 (if provided). Selector 604 may then select locators 204, and output selected locators 614, based on select signal(s) 610. Accordingly, the ability to select associated content for an area or region may be provided.

For example, consider the geodetic coordinates of San Francisco and San Jose, which in decimal form may be {37.757687, −122.415161} and {37.335224, −121.898804}, respectively. In hexadecimal, these values are {24022F7, −74BE839} and {239B0B8, −7440734}, respectively. Thus, with the geographic coordinates stored in binary form, with appropriate masks, geographic coordinate indices indexing San Francisco and San Jose to associated contents may be selected for a search query searching for relevant contents for the Bay Area.

While for thoroughness, the present disclosure has been described thus far with the lowest level of geographic coordinates based indices indexing Earth positions to associated contents, in embodiments, the “lowest” level of geographic coordinates based indices may be indices of geographic coordinate ranges indexing areas and/or regions instead.

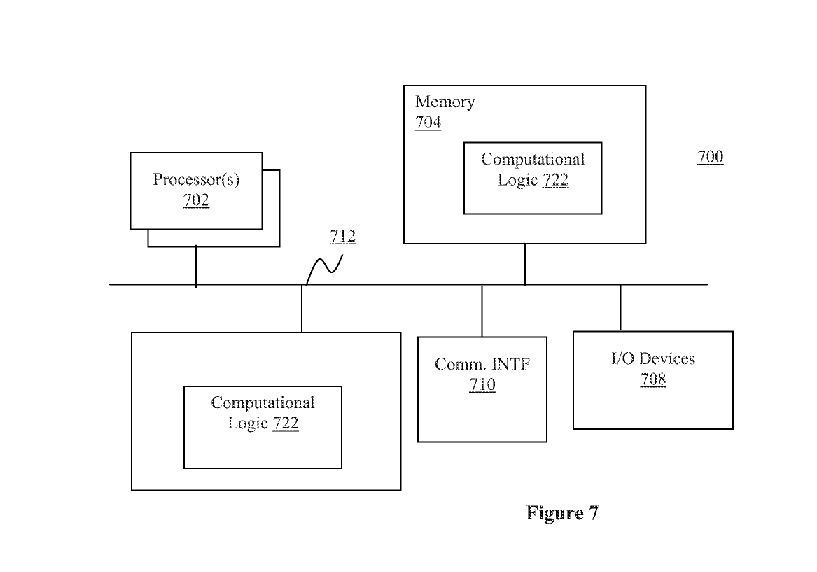

Referring now to FIG. 7, wherein an example computer suitable for use as either client device 102 or server 104 of FIG. 1, in accordance with various embodiments, is illustrated. As shown, computer 700 may include one or more processors or processor cores 702, and system memory 704. For the purpose of this application, including the claims, the terms “processor” and “processor cores” may be considered synonymous, unless the context clearly requires otherwise. System memory 704 may include volatile and or non-volatile memory, including CAM. Additionally, computer 700 may include mass storage devices 706 (such as diskette, hard drive, compact disc read only memory (CD-ROM) and so forth), input/output devices 708 (such as display, keyboard, cursor control and so forth) and communication interfaces 710 (such as network interface cards, modems and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the various operations earlier described, e.g., the operations associated with search engine 116 and/or indexing engine 118, collectively denoted as computational logic 722. Computational logic 722 may be implemented with assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of computational logic 722 may be employed to distribute computational logic 722 and program various computing devices.

The number, capability and/or capacity of these elements 710-712 may vary, depending on whether computer 700 is used as a client device 102 or server 104. When use as client device 102, whether client device 102 is a stationary or mobile device, like a smartphone, computing tablet, ultrabook or laptop, with general or specific applications. The constitutions of these elements are otherwise known, and accordingly will not be further described.

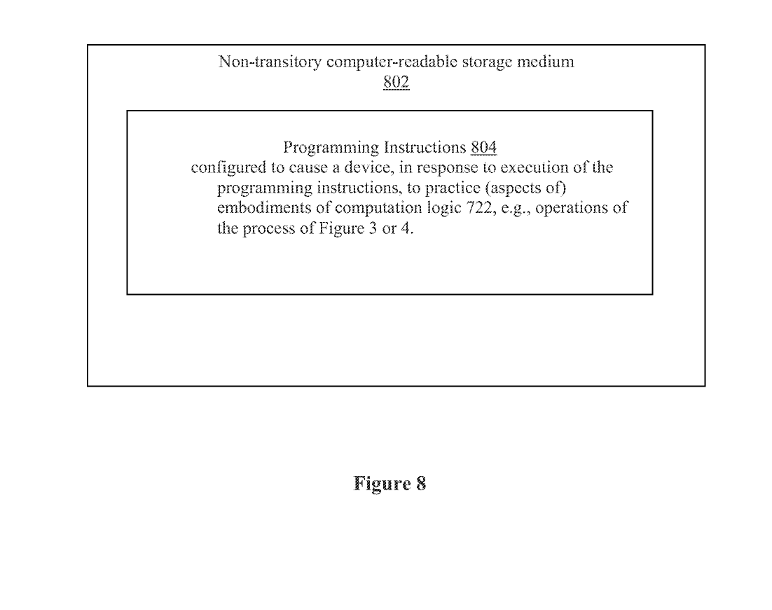

FIG. 8 illustrates an example non-transitory computer-readable storage medium having instructions configured to practice all or selected ones of the operations associated with search engine 116 and/or indexing engine 118, earlier described; in accordance with various embodiments. As illustrated, non-transitory computer-readable storage medium 802 may include a number of programming instructions 804. Programming instructions 804 may be configured to enable a device, e.g., computer 400, in response to execution of the programming instructions, to perform various ones of the earlier described operations, e.g., various operations of process 300 of FIG. 3 or process 400 of FIG. 4. In alternate embodiments, programming instructions 804 may be disposed on multiple non-transitory computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method, comprising:
analyzing a plurality of contents having non-geographic coordinate content items, including determining whether the non-geographic coordinate content items are associated with a plurality of locations on Earth's surface, identifiable by a plurality of geographic coordinates of a geographic coordinate system;
for contents, among the plurality of contents, with non-geographic coordinate content items recognized to be associated a plurality of locations, generating and storing indices that index the geographic coordinates of the locations to the contents with associated non-geographic coordinate content items;
receiving a search query; and
generating and returning an answer set to the search query, the answer set including locators to potentially relevant contents, and generating including selecting the locators to potentially relevant contents based at least in part on the stored indices.

2. The method of claim 1, wherein the geographic coordinates comprise geodetic coordinates, geocentric coordinates or spherical coordinates, and wherein an index comprises geographic coordinates of a location, and a locator to the content associated with the location.

3. The method of claim 1, wherein the contents comprise multi-media objects, and the non-geographic coordinate content items include non-geographic coordinate content items in metadata of the multi-media objects.

4. The method of claim 1, wherein generating of indices further comprises generating a plurality of intermediate indices indexing a plurality of geographic coordinate ranges of a plurality of regions of Earth's surface to one another or to the indices of the geographic coordinates, and storing comprises storing the indices in a hierarchical data structure having a plurality of levels, including storing the indices of the geographic coordinates in the lowest level of the plurality of levels; and the intermediate indices in one or more intermediate levels of the plurality of levels.

5. The method of claim 1, wherein generating and returning an answer set comprises:
processing the search query, including analyzing association of non-geographic coordinate search criteria of the search query with locations of Earth's surface; and
traversing the stored geographic coordinates based indices based at least in part on geographic coordinates of the locations associated with the non-geographic coordinate search criteria.

6. At least one non-transitory storage medium comprising a plurality of instructions configured to cause a computing device, in response to execution of the instructions by the computing device, to:
analyze a plurality of contents having non-geographic coordinate content items, wherein analyze includes determine whether the non-geographic coordinate content items are associated with a plurality of locations on Earth's surface, identifiable by a plurality of geographic coordinates of a geographic coordinate system; and
for contents, among the plurality of contents, with non-geographic coordinate content items recognized to be associated a plurality of locations, generate and store indices that index the geographic coordinates of the locations to the contents with associated non-geographic coordinate content items.

7. The storage medium of claim 6, wherein the geographic coordinates comprise geodetic coordinates, geocentric coordinates or spherical coordinates.

8. The storage medium of claim 6, wherein an index comprises geographic coordinates of a location, and a locator to the content associated with the location.

9. The storage medium of claim 6, wherein the contents comprise multi-media objects, and the non-geographic coordinate content items include non-geographic coordinate content items in metadata of the multi-media objects.

10. The storage medium of claim 6, wherein generate indices further comprises generate a plurality of intermediate indices indexing a plurality of geographic coordinate ranges of a plurality of regions of Earth's surface to one another or to the indices of the geographic coordinates; and wherein store comprises store the indices in a hierarchical data structure having a plurality of levels, including storage of the indices of the geographic coordinates in the lowest level of the plurality of levels, and store the intermediate indices in one or more intermediate levels of the plurality of levels.

11. The storage medium of claim 10, wherein the plurality of intermediate indices include a first subset of intermediate indices indexing a first subset of the plurality of geographic coordinate ranges defining a plurality of regions of a plurality of countries on Earth's surface to the indices of the geographic coordinates, and wherein storage of the intermediate indices comprises storage of the first subset of intermediate indices at a first intermediate level of the plurality of levels immediately above the lowest level.

12. The storage medium of claim 11, wherein the plurality of intermediate indices include a second subset of intermediate indices indexing a second subset of the plurality of geographic coordinate ranges defining the plurality of countries, to the indices of the plurality of regions of the plurality of countries, and wherein storage of the intermediate indices comprises storage of the second subset of intermediate indices at a second intermediate level of the plurality of levels immediately above the first intermediate level.

13. The storage medium of claim 12, wherein the plurality of intermediate indices include a third subset of intermediate indices indexing a third subset of the plurality of geographic coordinate ranges defining a plurality of continents, to the indices of the plurality of countries, and wherein storage of the intermediate indices comprises storage of the third subset of intermediate indices at a third intermediate level of the plurality of levels immediately above the second intermediate level.

14. The storage medium of claim 6, wherein the instructions, in response to execution by the computing device, further causes the computing device to:
receive a search query; and
generate and return an answer set to the search query, wherein the answer set includes locators to potentially relevant contents, and wherein generate includes selection of the locators to potentially relevant contents based at least in part on the stored indices.

15. The storage medium of claim 14, wherein generate comprises:
process the search query, including analysis of association of non-geographic coordinate search criteria of the search query with locations of Earth's surface; and
traversal of the stored geographic coordinates based indices based at least in part on geographic coordinates of the locations associated with the non-geographic coordinate search criteria.

16. The storage medium of claim 15, wherein process the search query further comprises translation of a non-geographic coordinate search criteria to a geographic coordinate of an associated location or a range of geographic coordinates of an area that includes an associated location.

17. The storage medium of claim 16, wherein store comprises store the indices in a hierarchical data structure having a plurality of levels, including storage of the indices in the lowest level of the plurality of levels; and wherein for a non-geographic coordinate search criteria translated to a range of geographic coordinates, traversal of the stored geographic coordinates based indices comprises traversal of at least an intermediate level of the plurality of levels to reach the lowest level where the geographic coordinates based indices to associated contents are stored.

18. At least one non-transitory storage medium comprising a plurality of instructions configured to cause a computing device, in response to execution of the instructions by the computing device, to:
receive a search query; and
generate and return an answer set to the search query, having a plurality of locators of potential relevant contents, based at least in part on a plurality of geographic coordinates based indices indexing a plurality of geographic coordinates of a geographic coordinate system to contents associated with locations of Earth's surface identified by the geographic coordinates, wherein the geographic coordinates based indices are generated and stored based on association of non-geographic coordinate content items of the contents with the geographic coordinates.

19. The storage medium of claim 18, wherein generate and return comprises:
process the search query, including analysis of association of non-geographic coordinate search criteria of the search query with locations of Earth's surface; and
traversal of the stored geographic coordinates based indices based at least in part on geographic coordinates of the locations associated with the non-geographic coordinate search criteria.

20. The storage medium of claim 19, wherein process the search query further comprises translation of a non-geographic coordinate search criteria to a geographic coordinate of an associated location or a range of geographic coordinates of an area that includes an associated location.

21. The storage medium of claim 20, wherein the plurality of geographic coordinates based indices are stored in a hierarchical data structure having a plurality of levels, including the lowest level and one or more intermediate levels; and wherein for a non-geographic coordinate search criteria translated to a range of geographic coordinates, generate and return comprises traversal of at least an intermediate level of the plurality of levels to reach the lowest level where the geographic coordinates based indices to associated contents are stored.

22. An apparatus comprising:
one or more processors; and
a search service configured to be operated by the one or more processors, wherein the search service includes an indexing engine configured to:
analyze a plurality of contents having non-geographic coordinate content items, wherein analyze includes determine whether the non-geographic coordinate content items are associated with a plurality of locations on Earth's surface, identifiable by a plurality of geographic coordinates of a geographic coordinate system; and
for contents, among the plurality of contents, with non-geographic coordinate content items recognized to be associated a plurality of locations, generate and store indices that index the geographic coordinates of the locations to the contents with associated non-geographic coordinate content items.

23. The apparatus of claim 22, wherein the indexing engine is further configured to analyze association of non-geographic coordinate content items of metadata of the content with locations of Earth's surface.

24. An apparatus comprising:
one or more processors;
a search service configured to be operated by the one or more processors, wherein the search service includes a search engine configured to:
receive a search query; and
generate and return an answer set to the search query, having a plurality of locators of potential relevant contents, based at least in part on a plurality of geographic coordinates based indices indexing a plurality of geographic coordinates of a geographic coordinate system to contents associated with locations of Earth's surface identified by the geographic coordinates, wherein the geographic coordinates based indices are generated and stored based on association of non-geographic coordinate content items of the contents with the geographic coordinates.

25. The apparatus of claim 24, wherein the search engine is further configured to:
process the search query, including analysis of association of non-geographic coordinate search criteria of the search query with locations of Earth's surface; and
traversal of the stored geographic coordinates based indices based at least in part on geographic coordinates of the locations associated with the non-geographic coordinate search criteria.
